(19) United States
(12) Patent Application Publication
(10) Pub. No.: US 2006/0258437 A1
(43) Pub. Date: Nov. 16, 2006

(54) GAMING MACHINE

(75) Inventor: Akira OSAWA, Koto-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/382,176

(22) Filed: May 8, 2006

(30) Foreign Application Priority Data
May 16, 2005 (JP) 2005-142877

(51) Int. Cl. A63F 13/00

(52) U.S. Cl. 463/20

(57) ABSTRACT

To provide a gaming machine on which a player can arbitrarily cause an activated pay line to be displayed in reel symbol display areas. In the event that a LINE ACTIVE button is depressed once, the activated pay line corresponding to the number of bets is displayed in variable display windows. In this condition, in the event that a prescribed time has elapsed, the state is established in which the activated pay line corresponding to the number of bets is displayed in variable display windows. In the event that the prescribed time has elapsed and the LINE ACTIVE button is depressed again, second symbol display areas are displayed. In this condition, in the event that the prescribed time has elapsed, the state is established in which the second symbol display areas are displayed. In the same way, in the event that the LINE ACTIVE button is depressed again, first symbol display areas and third symbol display areas are displayed in order.

### RELATED APPLICATION

This application claims the priority of Japanese Patent Application No. 2005-142877 filed on May 16, 2005, which is incorporated herein by reference.

### BACKGROUND OF THE INVENTION

1. Technical Field

The present invention relates to a gaming machine, and more particularly to a gaming machine capable of displaying an activated pay line as needed.

2. Related Art

The existing gaming machine, for example, a slot machine, is configured in such a way that a playing value such as a coin is paid out in response to a combination of symbols on the reels placed in a stationary state a plurality of reels are rotated for a predetermined period of time and (refer to Japanese Unexamined Patent Publication No. 7-313659). The combination of symbols for which a playing value such as a coin is paid out is a combination of symbols arranged on an activated pay line among a multiplicity of pay lines. In recent years, the gaming machine, which uses a liquid crystal display device, has been configured in such a way that the liquid crystal display device displays an activated pay line in its plurality of symbolol display areas, so that a player can recognize the activated pay line.

However, in recent years, in the gaming machine, it has been demanded to effectively use the liquid crystal display device for the purpose of carrying out an effect for a bonus game, because of which the activated pay line is normally deleted from a screen.

In recent years, in the gaming machine, the number of activated pay lines has been increased, for example, up to 25 or 30. As the number of activated pay lines has thus been increased, the pattern of the activated pay lines becomes complicated, meaning that the player may not recognize the activated pay lines. In such a case, an aspect whereby the activated pay line can be arbitrarily displayed in the reel symbol display areas has been desired.

### SUMMARY OF THE INVENTION

The invention has been made in view of such a point, and an object of the invention is to provide a gaming machine on which a player can arbitrarily cause an activated pay line to be displayed in reel symbol display areas.

The gaming machine of the invention comprises: a display device which displays a plurality of symbol display areas; a game controller which pays out a playing value in response to a symbol combination on at least one activated pay line (symbols stopped on an activated pay line or a combination thereof); and a line active module which causes the activated pay line to be displayed on the plurality of symbol display areas according to an input operation.

According to this configuration, by an intentional operation of the line active module by the player, it is possible to display the activated pay line in the reel symbol display areas. Consequently, even though the number of activated pay lines is increased, the player can recognize the activated pay lines.

In the gaming machine of the invention, it is preferable that the line active module activates a predetermined display area of the reel symbol display areas. As used herein, the aspect of activating the display area refers to changing the brightness of the relevant display area, changing the color of the relevant display area, and making the relevant display area easily visible to the player. In this case, it is acceptable that a normal activated pay line is included in the relevant display area. According to this configuration, from the aspect etc. of winning a bonus when specified symbols have been displayed in a stationary form in specified symbol display areas, it becomes easy for the player to recognize the symbol display areas related to the winning of the bonus. Thus, it is possible to further increase player's interest in the bonus game.

The gaming machine of the invention comprises: a display device which displays at least reel symbol display areas; a game controller which pays out a playing value in response to a combination of symbols stopped on at least one activated pay line in the display device; and a line active module which causes the activated pay line to be displayed on the reel symbol display areas according to an input operation. Therefore, the player can arbitrarily cause the activated pay line to be displayed in the reel symbol display areas.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

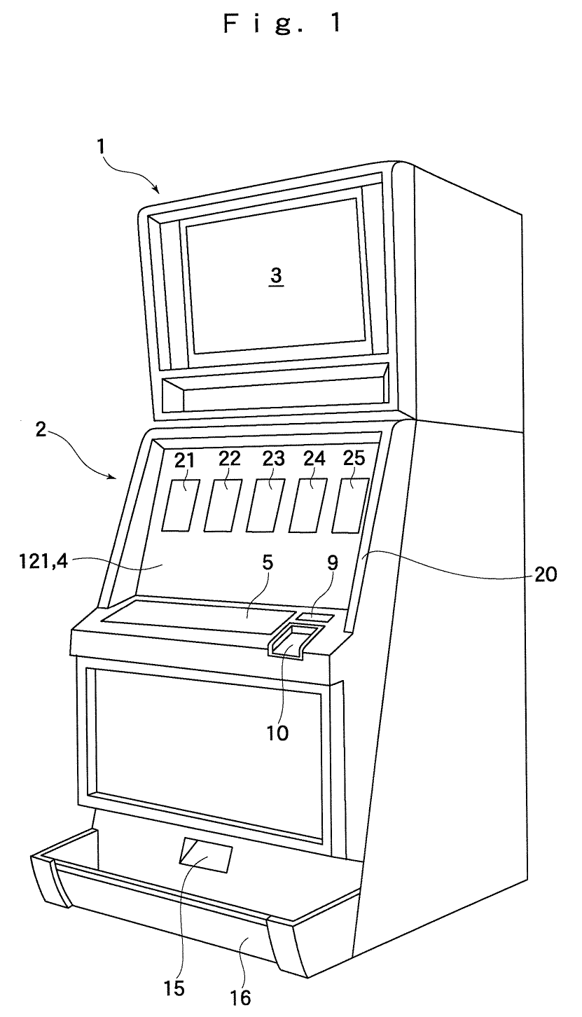

FIG. 1 is a perspective view showing a slot machine which is a gaming machine according to one example of the invention;

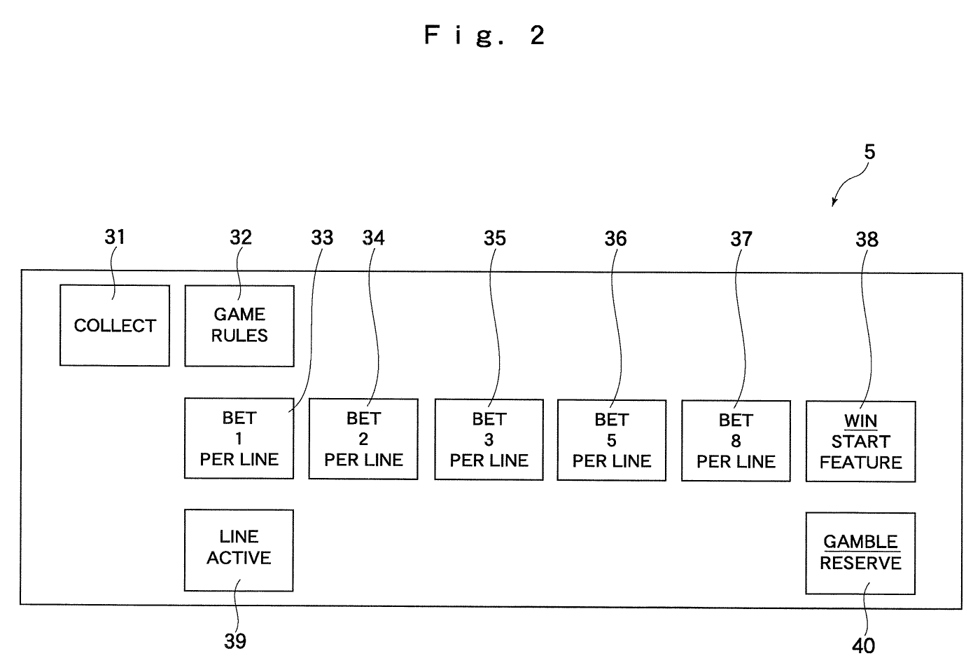

FIG. 2 is a diagram showing an arrangement of buttons on an operating table;

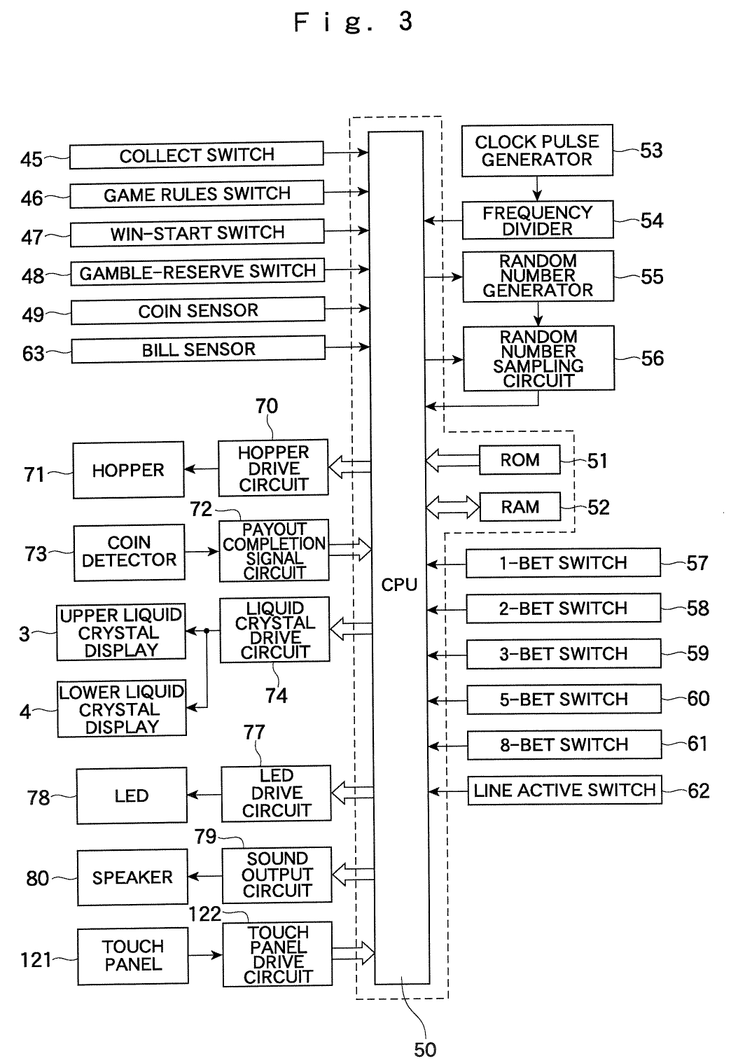

FIG. 3 is a block diagram schematically showing a control system of the slot machine;

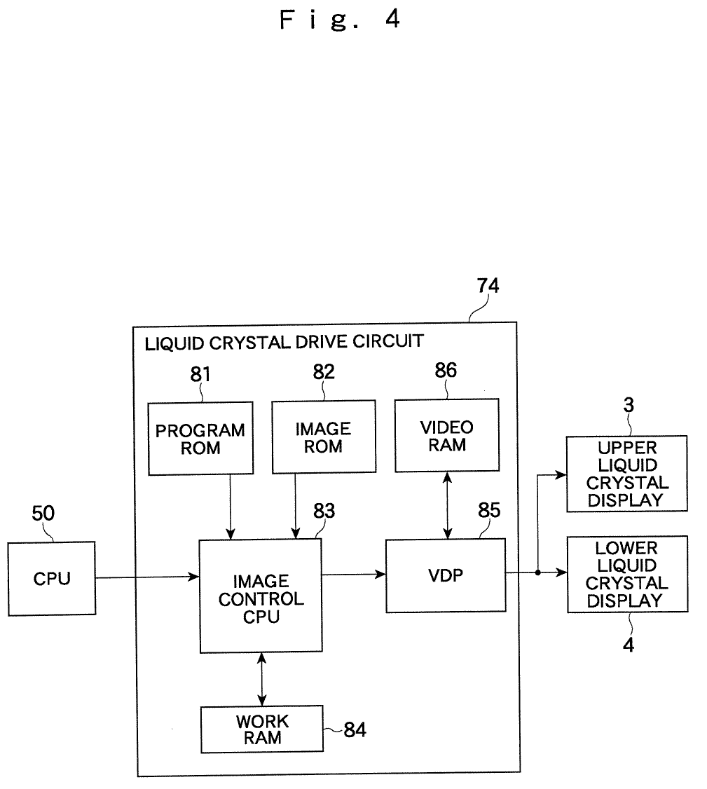

FIG. 4 is a block diagram showing a configuration of a liquid crystal drive circuit;

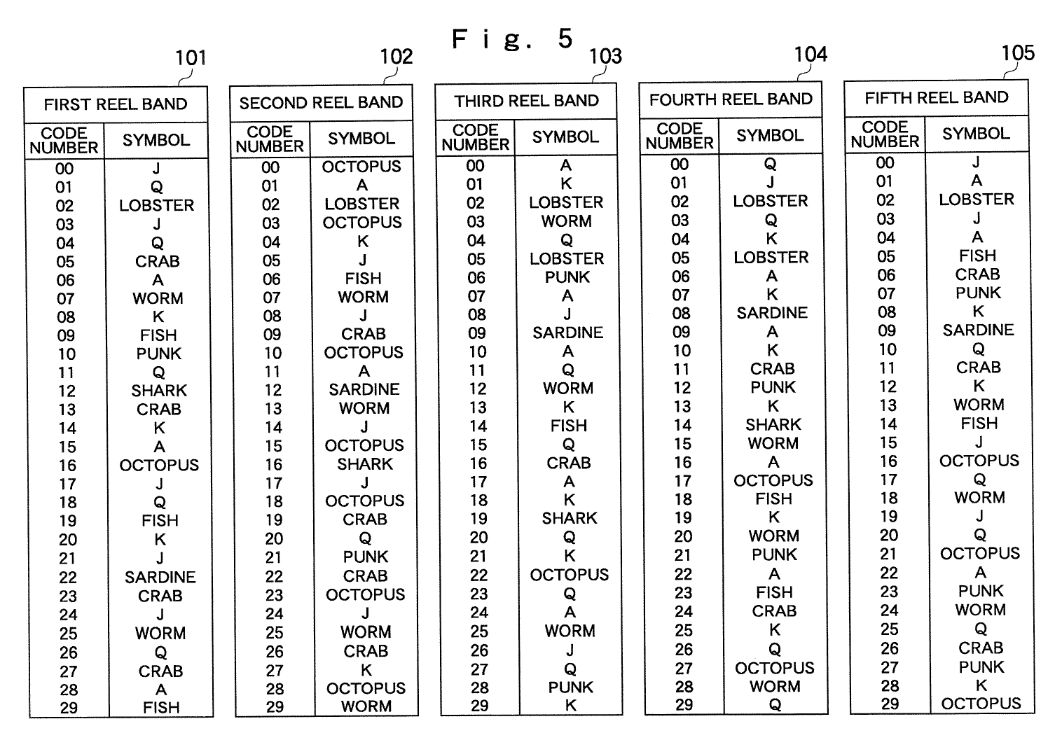

FIG. 5 is a diagram showing reel bands of the slot machine;

FIG. 6 is a diagram for illustrating variable display windows of the slot machine;

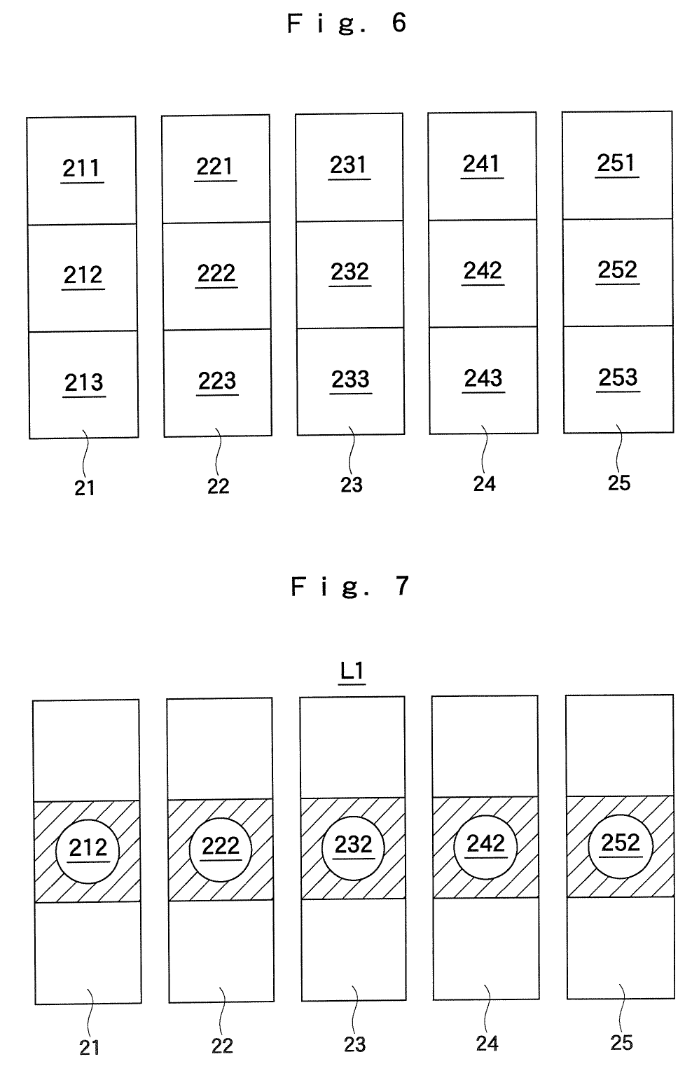

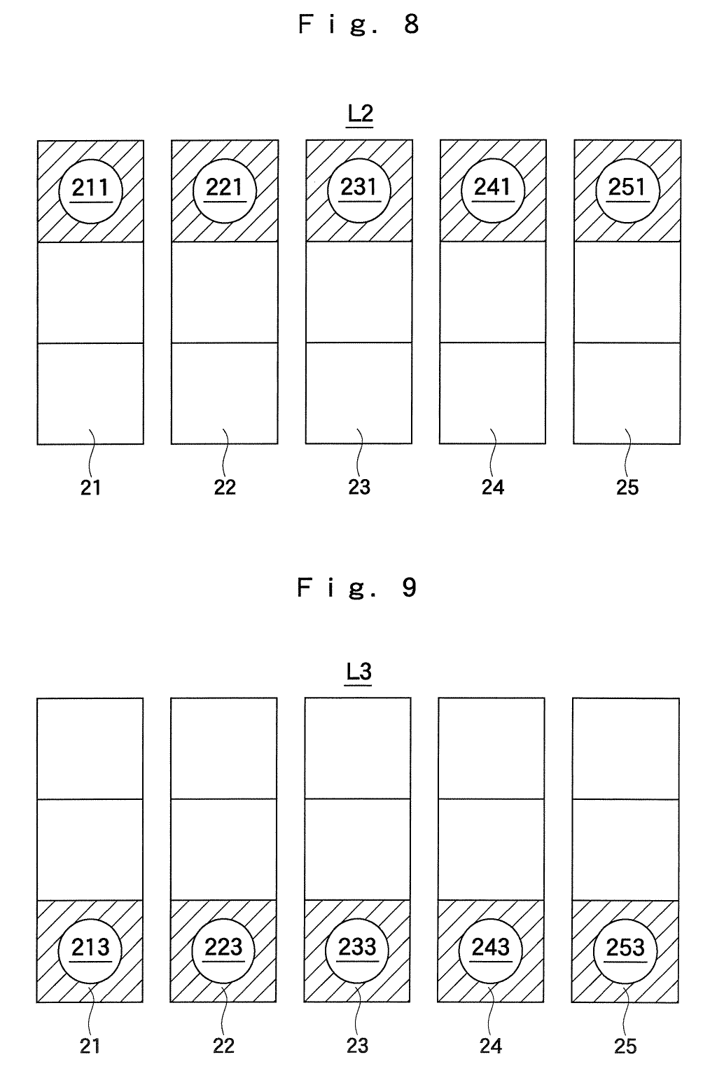

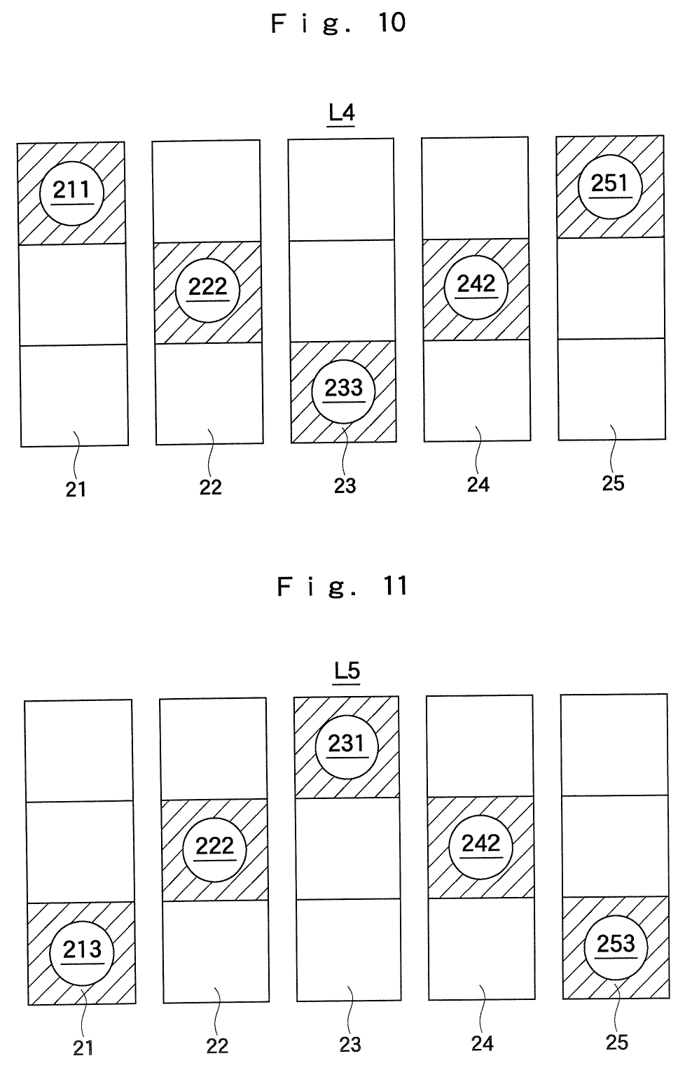

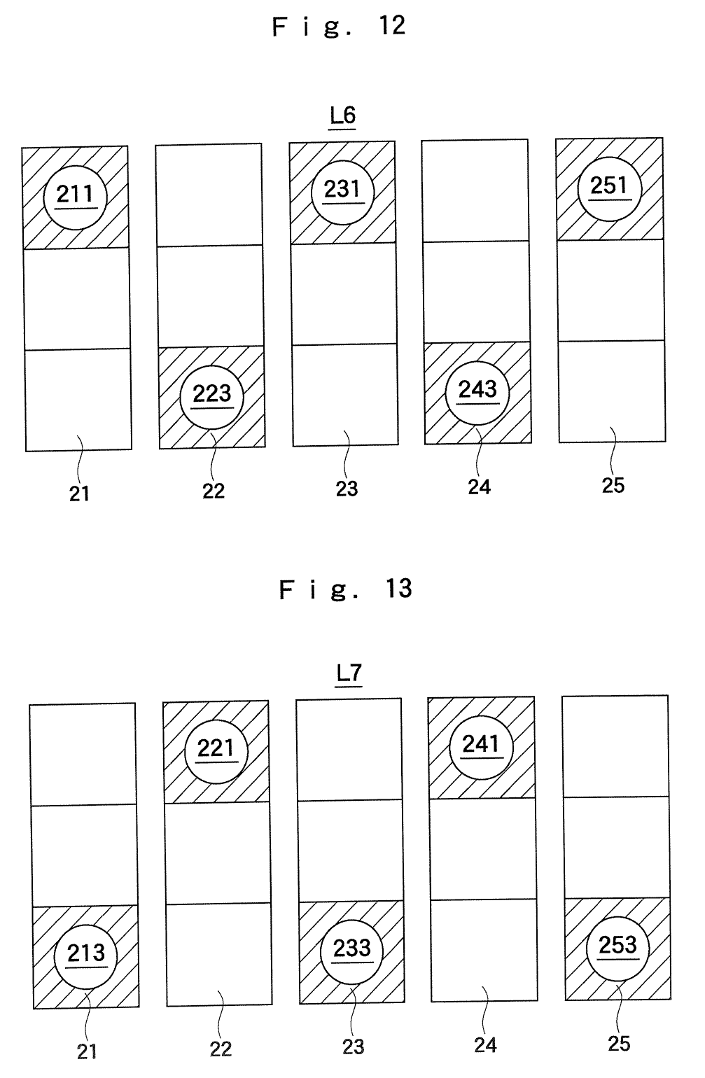

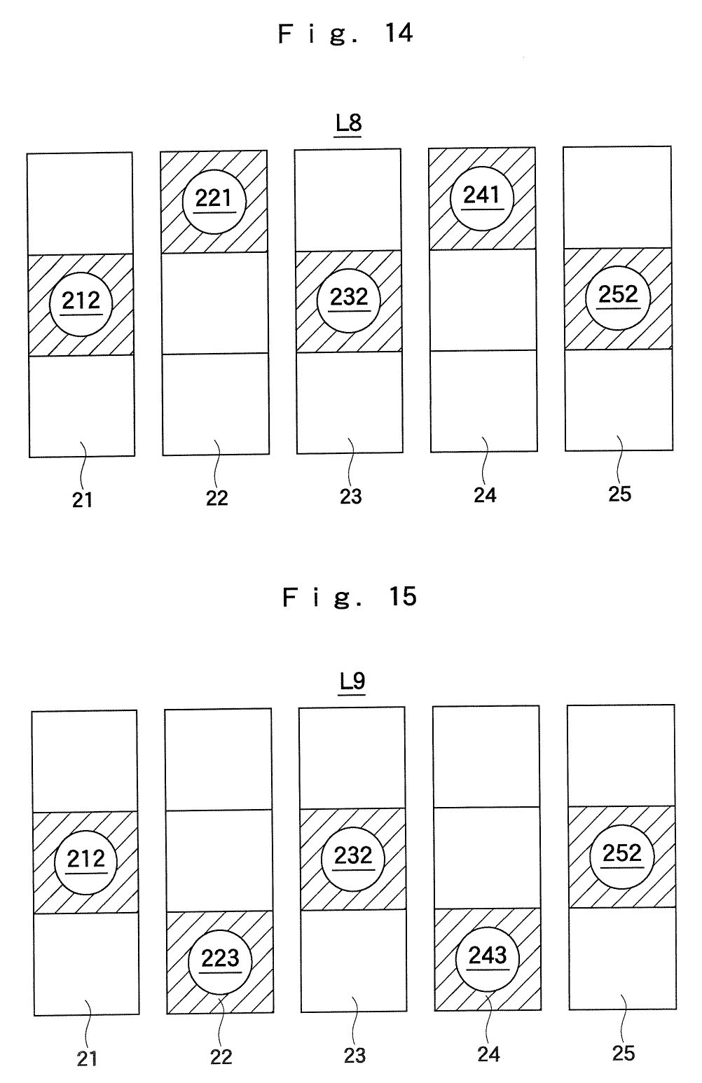

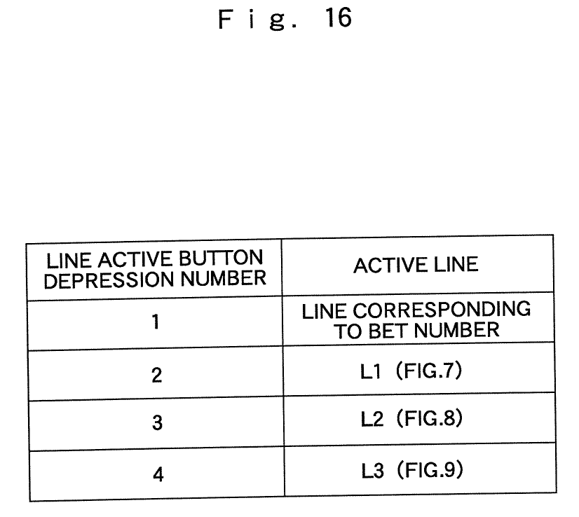

FIG. 7 is a diagram showing a pay line L1 in the variable display windows;

FIG. 8 is a diagram showing a pay line L2 in the variable display windows;

FIG. 9 is a diagram showing a pay line L3 in the variable display windows;

FIG. 10 is a diagram showing a pay line L4 in the variable display windows;

FIG. 11 is a diagram showing a pay line L5 in the variable display windows;

FIG. 12 is a diagram showing a pay line L6 in the variable display windows;

FIG. 13 is a diagram showing a pay line L7 in the variable display windows;

FIG. 14 is a diagram showing a pay line L8 in the variable display windows;

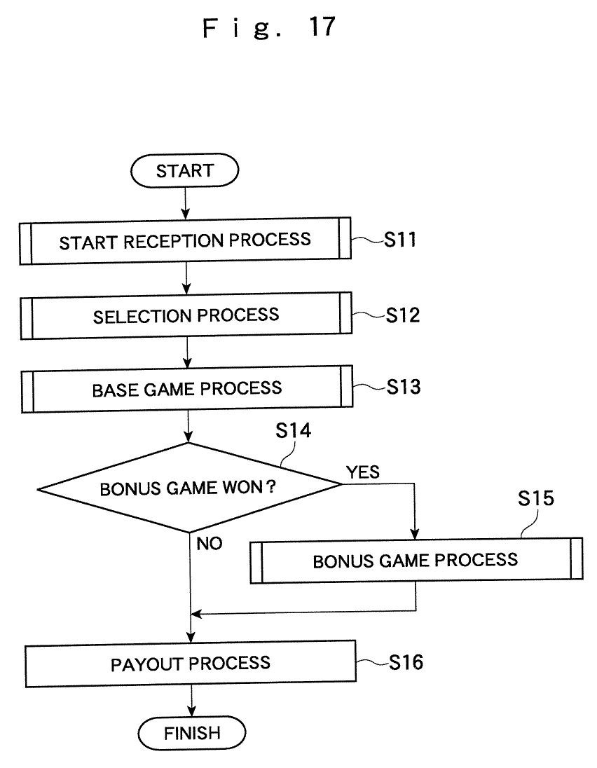

FIG. 15 is a diagram showing a pay line L9 in the variable display windows;

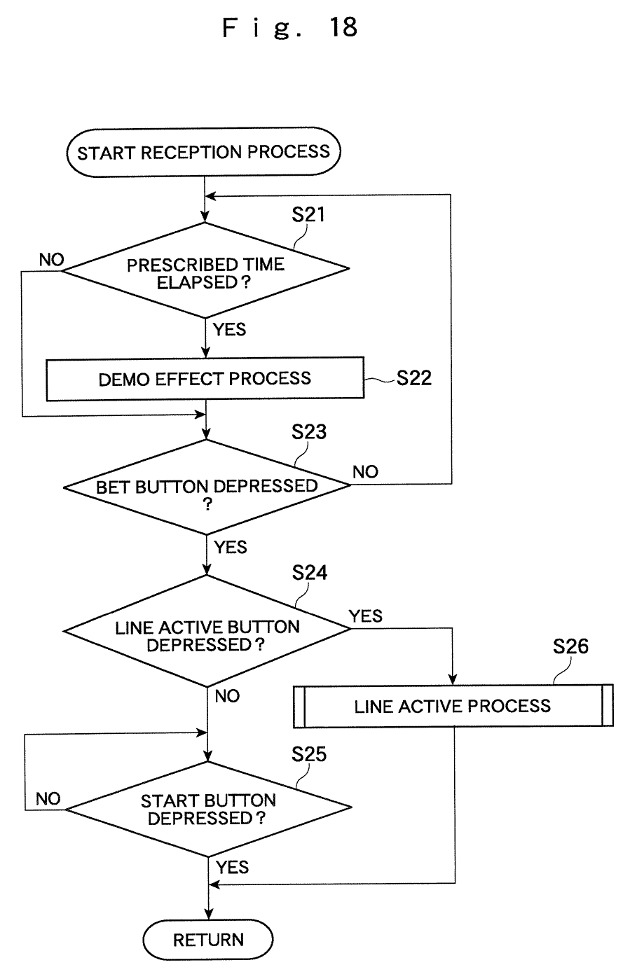

FIG. 16 is a diagram showing a relationship between a LINE ACTIVE button depression number and an active line;

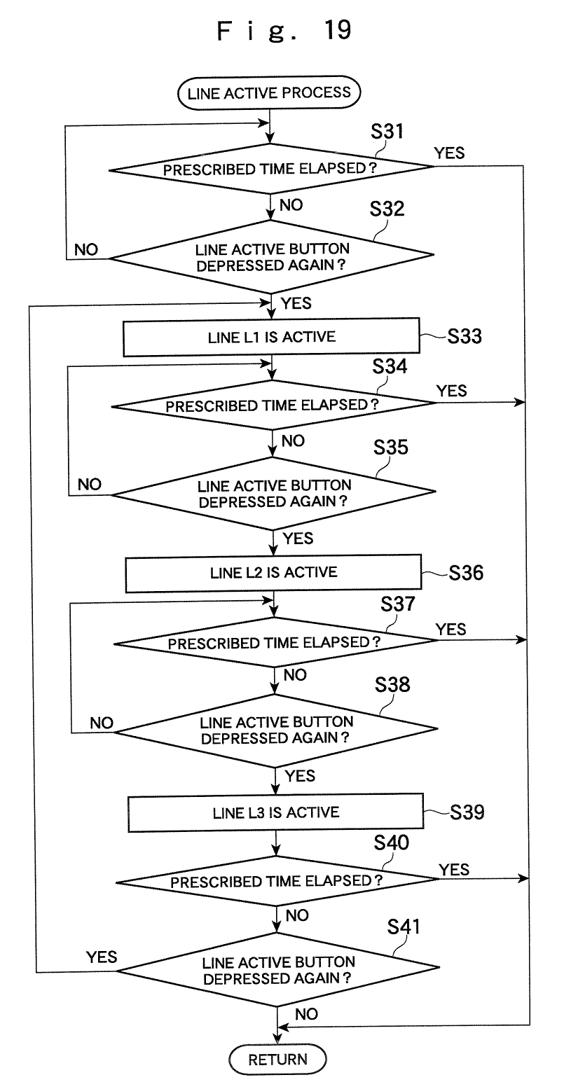

FIG. 17 is a flowchart illustrating a main process program of the slot machine;

FIG. 18 is a flowchart illustrating a start reception process program;

FIG. 19 is a flowchart illustrating a line active process program;

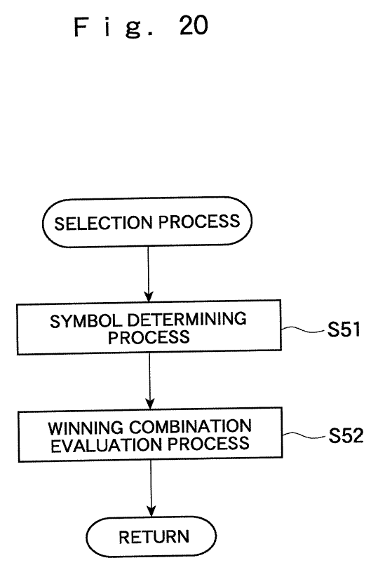

FIG. 20 is a flowchart illustrating a selection process program;

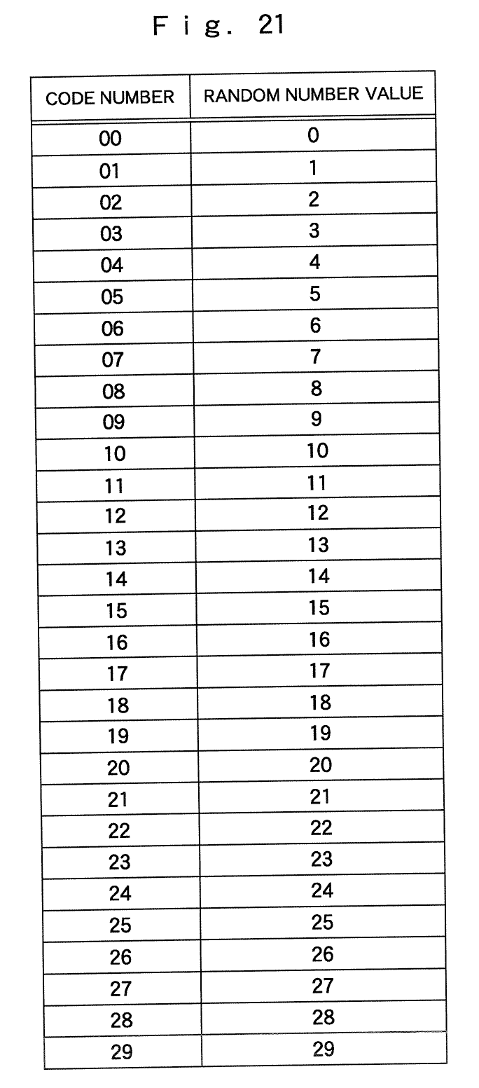

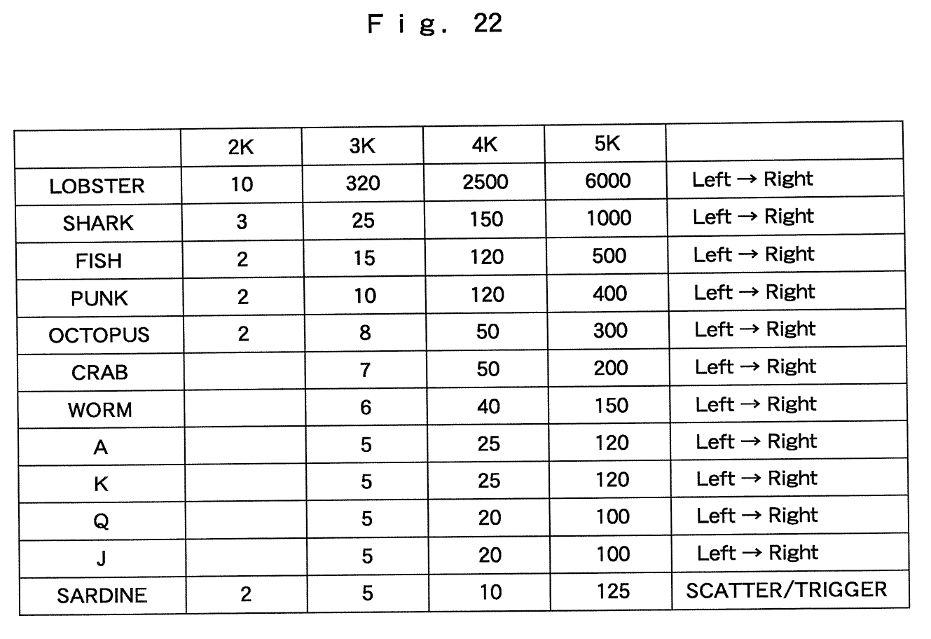

FIG. 21 is a diagram showing a selection table;

FIG. 22 is a diagram showing a table relating to winning combinations and the awards thereof;

FIG. 23 is a flowchart illustrating a base game process program;

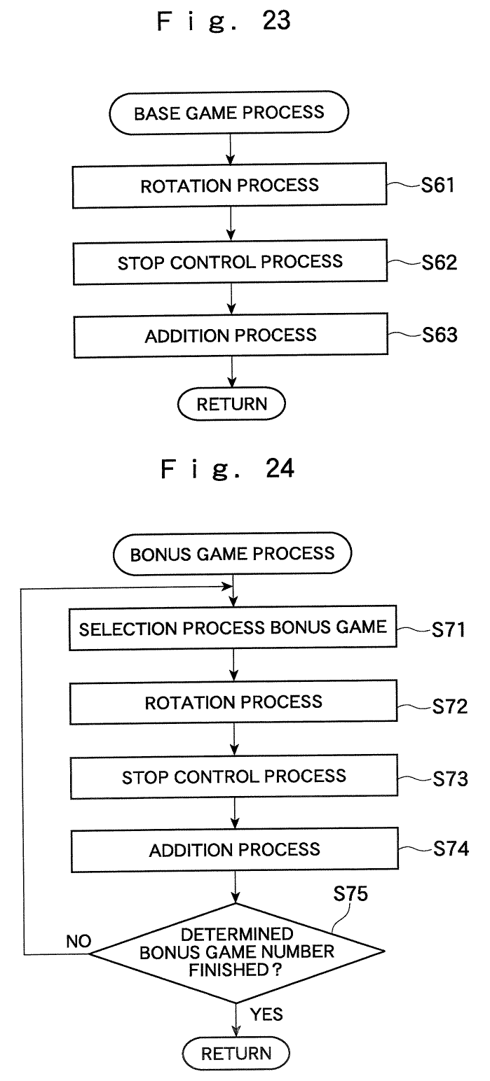

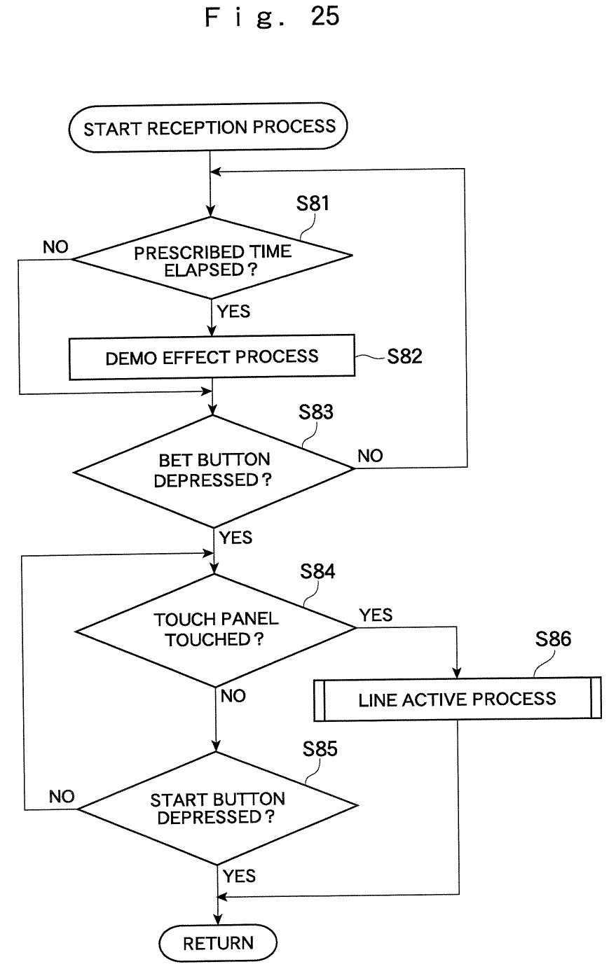

FIG. 24 is a flowchart illustrating a bonus game process program;

FIG. 25 is a flowchart illustrating another example of the start reception process program; and

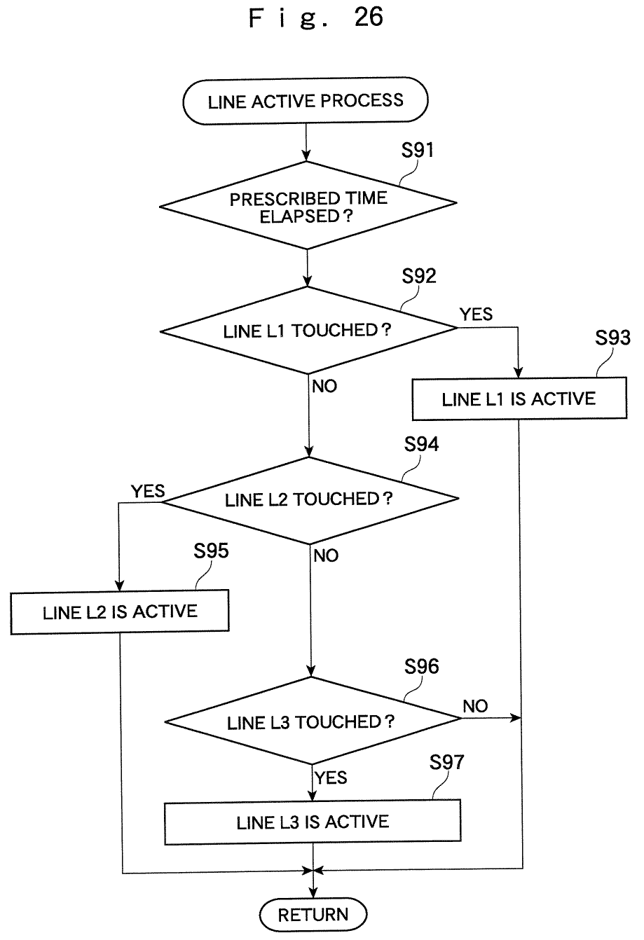

FIG. 26 is a flowchart illustrating another example of the line active process program.

### DESCRIPTION OF THE PREFERRED EMBODIMENT(S)

An embodiment of the invention will hereafter be described in detail with reference to the accompanying drawings.

FIG. 1 is a perspective view showing a slot machine which is a gaming machine according to one embodiment of the invention. In FIG. 1, a slot machine 1 has a cabinet 2 which forms the whole of the slot machine 1, wherein an upper liquid crystal display 3 is disposed in the top of the front of such a cabinet 2, and a lower liquid crystal display 4 is disposed in an instrument front panel 20 provided in the central portion of the front of the cabinet 2. The upper liquid crystal display 3 and the lower liquid crystal display 4 are configured from a generally used liquid crystal display. Information relating to a game such as a playing method, a kind of winning combination and its award, and various effects relating to the game, are displayed on the upper liquid crystal display 3. Also, the lower liquid crystal display 4 is equipped with a touch panel 121 on its screen. Furthermore, as well as credits being displayed, basically, five variable display windows 21 to 25 are displayed on the lower liquid crystal display 4. In each of the variable display windows 21 to 25, a variety of symbols to be described hereafter are variably displayed as they are scrolled from an upper direction to a lower direction, and are thereafter displayed in a stationary form.

Consequently, on the slot machine 1, a slot game (a base game and a bonus game) is performed using a video reel which is actualized by being displayed via each of the variable display windows 21 to 25 in the lower liquid crystal display 4. In the slot game, there are three symbols which are displayed in a stationary form in each of the variable display windows 21 to 25. That is, as shown in FIG. 6, the variable display windows 21 to 25 are divided respectively into first symbol display areas 211, 221, 231, 241 and 251, second symbol display areas 212, 222, 232, 242 and 252 and third symbol display areas 213, 223, 233, 243 and 253, wherein a symbol is displayed in a stationary form in each of the symbol display areas 211 to 213, 221 to 223, 231 to 233, 241 to 243 and 251 to 253. The number and layout of symbol display areas are not limited to this configuration, but can be changed as appropriate.

An operating table 5 is provided, projecting forwards, at the bottom of the lower liquid crystal display 4. Also, a coin insertion slot 9 and a bill insertion slot 10 are provided on the right-hand side of the operating table 5. Furthermore, a coin payout opening 15 and a coin receiving tray 16, which receives the coins paid out from the coin payout opening 15, are provided at the bottom of the front of the cabinet 2.

As shown in FIG. 2, a COLLECT button 31 and a GAME RULES button 32 are provided on the top row of the operating table 5, also, a BET 1 PER LINE button 33, a BET 2 PER LINE button 34, a BET 3 PER LINE button 35, a BET 5 PER LINE button 36, a BET 8 PER LINE button 37 and a WIN START FEATURE button 38 are provided in the center row, and a LINE ACTIVE button 39 and a GAMBLE RESERVE button 40 are provided on the bottom row.

At this point, a description will be given, using FIG. 3, of a configuration relating to a control system of the slot machine 1. FIG. 3 is a block diagram schematically showing the control system of the slot machine. In the slot machine 1 shown in FIG. 3, an ROM 51 and an RAM 52 are connected to a CPU 50 which is a game controller. A main process program, to be described hereafter, a base game process program, a bonus game process program, a selection table for selecting a stationary display symbol for the base game, a selection table for selecting a stationary display symbol for the bonus game, as well as various kinds of program, data table and the like which are necessary for the control of the slot machine 1, are stored in the ROM 51. Also, the RAM 52 is a memory for temporarily storing the various kinds of data calculated by the CPU 50.

Also, a clock pulse generator 53, which generates a reference clock pulse, and a frequency divider 54 are connected to the CPU 50, as are a random number generator 55, which generates a random number, and a random number sampling circuit 56. The random number sampled via the random number sampling circuit 56 is used for the various kinds of selection of the winning combinations etc. Furthermore, a COLLECT switch 45 appended to the COLLECT button 31, a GAME RULES switch 46 appended to the GAME RULES button 32, a 1-BET switch 57 appended to the BET 1 PER LINE button 33, a 2-BET switch 58 appended to the BET 2 PER LINE button 34, a 3-BET switch 59 appended to the BET 3 PER LINE button 35, a 5-BET switch 60 appended to the BET 5 PER LINE button 36, an 8-BET switch 61 appended to the BET 8 PER LINE button 37, a LINE ACTIVE switch 62 appended to the LINE ACTIVE button 39, a WIN START switch 47 appended to the WIN START FEATURE button 38, and a GAMBLE RESERVE switch 48 appended to the GAMBLE RESERVE button 40, are connected to the CPU 50. Based on the switch signal output by each switch according to the depression of each button, the CPU 50 carries out control so as to execute the various kinds of operation corresponding to each button.

Furthermore, a coin sensor 49 disposed in the coin insertion slot 9 and a bill sensor 63 disposed in the bill insertion slot 10 are connected to the CPU 50. The coin sensor 49 detects the coins inserted through the coin insertion slot 9, whereby the CPU 50 calculates the number of coins inserted based on the coin detection signal transmitted from the coin sensor 49. The bill sensor 63 detects the kind and value of the bills inserted through the bill insertion slot 10, whereby the CPU 50 calculates the number of credits equivalent to the value of the bills, based on the bill detection signal transmitted from the bill sensor 63.

A hopper 71 is connected to the CPU 50 via a hopper drive circuit 70. When a drive signal is transmitted to the hopper drive circuit 70 from the CPU 50, the hopper 71 pays out a prescribed number of coins from the coin payout opening 15. Also, a coin detector 73 is connected to the CPU 50 via a payout completion signal circuit 72. The coin detector 73 is disposed inside the coin payout opening 15 wherein, in a case in which a prescribed number of coins is detected to have been paid out from the coin payout opening 15, a coin payout detection signal is transmitted from the coin detector 73 to the payout completion signal circuit 72, based on which the payout completion signal circuit 72 transmits a payout completion signal to the CPU 50. Furthermore, the upper liquid crystal display 3 and the lower liquid crystal display 4 are connected to the CPU 50 via a liquid crystal drive circuit 74, wherein the display of the upper liquid crystal display 3 and the lower liquid crystal display 4 are controlled by the CPU 50.

As shown in FIG. 4, the liquid crystal drive circuit 74 mainly comprises a program ROM 81, an image ROM 82, an image control CPU 83, a work RAM 84, a VDP (video display processor) 85, a video RAM 86 and the like. An image control program related to the display on the upper liquid crystal display 3 and the lower liquid crystal display 4, and various kinds of selection table, are stored in the program ROM 81. Also, dot data for forming images, such as symbol columns shown on reel bands 101 to 105 in FIG. 5 displayed on the lower liquid crystal display 4 (or the variable display windows 21 to 25), is stored in the image ROM 82. Additionally, the image control CPU 83 determines the image to be displayed on the upper liquid crystal display 3 and the lower liquid crystal display 4 from the dot data previously stored in the image ROM 82, based on the parameters set by the CPU 50, in accordance with an image control program previously stored in the program ROM 81. Furthermore, the work RAM 84 is configured as a temporary storage module when the image control program is executed by the image control CPU 83. Further still, the VDP 85 forms an image corresponding to the display details determined by the image control CPU 83, and transmits it to the upper liquid crystal display 3 and the lower liquid crystal display 4. By this means, for example, the symbol columns and the like shown on the reel bands 101 to 105 are displayed in a scrolling form on the lower liquid crystal display 4 (or the variable display windows 21 to 25). The video RAM 86 is configured as a temporary memory when the image is formed by the VDP 85.

Also, LED's 78 are connected to the CPU 50 via an LED drive circuit 77. A large number of the LED's 78 are distributed on the front of the slot machine 1 wherein, when various kinds of effect are executed, illumination control is carried out by the LED drive circuit 77 based on a drive signal from the CPU 50. Furthermore, a sound output circuit 79 and a speaker 80 are connected to the CPU 50, wherein the speaker 80, based on an output signal from the sound output circuit 79, emits a variety of sound effects when various effects are performed.

Additionally, the touch panel 121 is connected to the CPU 50 via a touch panel drive circuit 122. When any one of the variable display windows 21 to 25 is touched, the touch panel 121, being provided on the screen of the lower liquid crystal display 4, recognizes the touched one via the touch panel drive circuit 122. Also, the touch panel 121 can even recognize which one of the first symbol display areas 211, 221, 231, 241 and 251, the second symbol display areas 212, 222, 232, 242 and 252 and the third symbol display areas 213, 223, 233, 243 and 253 is touched.

At this point, using FIG. 5, a description will be given of examples of the symbols which are variably displayed while scrolling down each of the variable display windows 21 to 25 which are the reel symbol display areas of the lower liquid crystal display 4 during the base game. In FIG. 5, the symbol column shown in the first reel band 101 is the symbol column variably displayed in the variable display window 21, the symbol column shown in the second reel band 102 is the symbol column variably displayed in the variable display window 22, the symbol column shown in the third reel band 103 is the symbol column variably displayed in the variable display window 23, the symbol column shown in the fourth reel band 104 is the symbol column variably displayed in the variable display window 24, and the symbol column shown in the fifth reel band 105 is the symbol column variably displayed in the variable display window 25. The symbol columns shown on the reel bands 101 to 105 have a different symbol distribution with respect to each other, wherein each of the symbol columns comprises a combination of twelve symbols LOBSTER, SHARK, FISH, PUNK, OCTOPUS, CRAB, WORM, A, K, Q, J and SARDINE.

In the event that the symbol columns shown in the reel bands 101 to 105 are displayed in a scrolling form and thereafter in a stationary form in the respective variable display windows 21 to 25, three of the symbols are displayed in a stationary form in each of the variable display windows, as described heretofore. Also, the slot machine 1 is the same as the existing slot machine in that each kind of winning combination is preset based on a plurality of combinations of the symbols and in that, when a combination of symbols corresponding to a winning combination stops on an activated pay line, the award corresponding to the winning combination is added to the credits. Thus, the description thereof will be omitted here.

The COLLECT button 31 of the operating table 5 shown in FIG. 2 is a button which is depressed at the end of the base game. When the COLLECT button 31 is depressed, coins of a value equivalent to a number of credits obtained in the game are repaid from the coin payout opening 15 into the coin receiving tray 16. In response to a depression of the COLLECT button 31, a switch signal is transmitted to the CPU 50 from the COLLECT switch 45. The GAME RULES button 32 is a button which is depressed in the event that a game operation method etc. is unclear. When the GAME RULES button 32 is depressed, various help information is displayed on the upper liquid crystal display 3 and the lower liquid crystal display 4. In response to a depression of the GAME RULES button 32, a switch signal is transmitted to the CPU 50 from the GAME RULES switch 46.

When a coin is inserted in the coin insertion slot 9, a coin detection signal is transmitted to the CPU 50 via the coin sensor 49, and an amount of credits equivalent to the coin inserted is added. Also, when a bill is inserted in the bill insertion slot 10, a bill detection signal is transmitted to the CPU 50 via the bill sensor 63, and an amount of credits equivalent to the bill inserted is added.

The BET 1 PER LINE button 33 is a button whereby, each time it is depressed, one bet is placed on each activated pay line. When the BET 1 PER LINE button 33 is depressed, a switch signal is transmitted to the CPU 50 from the 1-BET switch 57 in response to the depression. The BET 2 PER LINE button 34 is a button whereby, in response to a depression thereof, the game is started with two bets on each activated pay line. When the BET 2 PER LINE button 34 is depressed, a switch signal is transmitted to the CPU 50 from the 2-BET switch 58 in response to the depression.

The BET 3 PER LINE button 35 is a button whereby, in response to a depression thereof, the game is started with three bets on each activated pay line. When the BET 3 PER LINE button 35 is depressed, a switch signal is transmitted to the CPU 50 from the 3-BET switch 59 in response to the depression. Also, the BET 5 PER LINE button 36 is a button whereby, in response to a depression thereof, the game is started with five bets on each activated pay line. When the BET 5 PER LINE button 36 is depressed, a switch signal is transmitted to the CPU 50 from the 5-BET switch 60 in response to the depression.

The BET 8 PER LINE button 37 is a button whereby, in response to a depression thereof, the game is started with eight bets on each activated pay line. When the BET 8 PER LINE button 37 is depressed, a switch signal is transmitted to the CPU 50 from the 8-BET switch 61 in response to the depression. Consequently, by depressing the BET 1 PER LINE button 33, the BET 2 PER LINE button 34, the BET 3 PER LINE button 35, the BET 5 PER LINE button 36 and the BET 8 PER LINE button 37, it is possible to make one bet, two bets, three bets, five bets and eight bets, respectively. The number of bets is not limited to the above but can be changed as appropriate.

The WIN START FEATURE button 38 is a button for the purpose of starting the base game and the bonus game, and for adding the awards obtained in the bonus game to the credits. When the WIN START FEATURE button 38 is depressed, a switch signal is transmitted to the CPU 50 from the WIN START switch 47 in response to the depression.

The LINE ACTIVE button 39 is a button which is depressed in the case of displaying the activated pay line. That is, the LINE ACTIVE button 39 is a button which the player depresses when intending to display the activated pay line in the variable display windows 21 to 25. When the LINE ACTIVE button 39 is depressed, a switch signal is transmitted to the CPU 50 from the LINE ACTIVE switch 62 in response to the depression. By depressing the LINE ACTIVE button 39, even though the number of activated pay lines is increased, the player can recognize the activated pay lines. In this embodiment, the case is described wherein, when the game is started before a prescribed time has elapsed after a depression of the LINE ACTIVE button 39, the activated pay lines are displayed in the variable display windows 21 to 25, and when a prescribed time has elapsed after a depression of the LINE ACTIVE button 39, the activated pay lines disappear from the variable display windows 21 to 25. However, the configuration may be such that the display of the activated pay line in the variable display windows 21 to 25 comes on and off each time the depression of the LINE ACTIVE button 39 is repeated.

Also, in this embodiment, the setting is such that, when the LINE ACTIVE button 39 is depressed once, the activated pay line is displayed in the variable display windows 21 to 25, and such that, when the LINE ACTIVE button 39 is depressed again, the first symbol display areas 211, 221, 231, 241 and 251, the second symbol display areas 212, 222, 232, 242 and 252, and the third symbol display areas 213, 223, 233, 243 and 253 are displayed in order. That is, as shown in FIG. 16, when the LINE ACTIVE button 39 is depressed once, the activated pay line corresponding to the number of bets is displayed. When the LINE ACTIVE button 39 is depressed again within a prescribed time, a pay line L1 (FIG. 7) to be described hereafter is displayed. When the LINE ACTIVE button 39 is depressed again within a prescribed time, a pay line L2 (FIG. 8) to be described hereafter is displayed. When the LINE ACTIVE button 39 is depressed again within a prescribed time, a pay line L3 (FIG. 9) to be described hereafter is displayed. Such a configuration capable of selectively displaying the first to third symbol display areas makes it easy for the player, from the aspect etc. of winning a bonus when specified symbols are displayed in a stationary form in specified symbol display areas, to recognize the symbol display areas related to the winning of the bonus. Thus, it is possible to increase the player's interest in the bonus game. The pattern of the pay line (active line) displayed by depressing the LINE ACTIVE button 39 can be changed as appropriate. For example, the setting may be such that, when the LINE ACTIVE button 39 is depressed again after the activated pay line corresponding to the number of bets has been displayed, the symbol display areas (central areas and four corner areas) related to the bonus game are displayed in order. For example, when the specific symbols, for example, LOBSTER's, are stopped in prescribed positions (for example, four corners) of the symbol display areas, in the case of a setting of making a transition to the bonus game, the prescribed positions of the symbol areas are displayed in order (for example, four corners are displayed in order in a clockwise or counterclockwise direction).

The GAMBLE RESERVE button 40 is a button for the purpose of depressing when leaving a seat, and for proceeding to a double down game after the finish of the bonus game. When the GAMBLE RESERVE button 40 is depressed, a switch signal is transmitted to the CPU 50 from the GAMBLE RESERVE switch 48 in response to the depression.

In the case of the slot game (the base game and the bonus game), there are twenty-five pay lines formed of five of the symbol display areas 211 to 213, 221 to 223, 231 to 233, 241 to 243 and 251 to 253. In each pay line, in the event that it is activated, an award is allotted when, at the time each symbol is displayed in a stationary form, specified symbols are arranged in a specified manner. To describe the pay lines, for example, as shown in FIG. 7, the first pay line L1 is formed of the second symbol display areas 212, 222, 232, 242 and 252. Also, as shown in FIG. 8, the second pay line L2 is formed of the first symbol display areas 211, 221, 231, 241 and 251. As shown in FIG. 9, the third pay line L3 is formed of the third symbol display areas 213, 223, 233, 243 and 253. As shown in FIG. 10, a fourth pay line L4 is formed of the first symbol display areas 211 and 251, the second symbol display areas 222 and 242, and the third symbol display area 233. As shown in FIG. 11, a fifth pay line L5 is formed of the first symbol display area 231, the second symbol display areas 222 and 242, and the third symbol display areas 213 and 253. As shown in FIG. 12, a sixth pay line L6 is formed of the first symbol display areas 211, 231 and 251 and the third symbol display areas 223 and 243. As shown in FIG. 13, a seventh pay line L7 is formed of the first symbol display areas 221 and 241 and the third symbol display areas 213, 233 and 253. As shown in FIG. 14, an eighth pay line L8 is formed of the first symbol display areas 221 and 241 and the second symbol display areas 212, 232 and 252. As shown in FIG. 15, a ninth pay line L9 is formed of the second symbol display areas 212, 232 and 252 and the third symbol display areas 223 and 243. As used herein, an activated one of the twenty-five pay lines is referred to as an “activated pay line”. Also, the pay lines described here are for the purpose of illustration, and the pattern and number of pay lines are not limited to the above but can be changed in various ways.

Next, a description will be given of the main process program performed on the slot machine 1. FIG. 17 is a flowchart for illustrating the main process program of the slot machine. In FIG. 17, first, in step (hereafter abbreviated to S) 11, a start reception process is carried out. The process is one which receives a switch signal transmitted from the 1-BET switch 57, the 2-BET switch 58, the 3-BET switch 59, the 5-BET switch 60 and the 8-BET switch 61, based on an operation of the BET 1 PER LINE button 33, an operation of the BET 2 PER LINE button 34, an operation of the BET 3 PER LINE button 35, an operation of the BET 5 PER LINE button 36 and an operation of the BET 8 PER LINE button 37. The game is started at the point when the switch signal transmitted from each switch is received by the CPU 50. Also, the start reception process is one which receives a control signal transmitted from the touch panel drive circuit 122 in response to a touch of the touch panel 121.

In S12, a selection process is carried out based on the switch signal transmitted from each switch. At this point, in the case of winning the bonus game, a bonus game repetition number is determined wherein, for example, one number of games is selected by lot from 10 to 25 games. In S13, a base game process is carried out. After that, in S14, it is determined whether or not the bonus game has been won. Specifically, in the event that, in the selection process in S12, for example, a total of three or more of the SARDINE symbols (sardine) appears (displayed in a stationary form), regardless of the activated pay line, in the variable display windows 21 to 25, the bonus game is won (S14). In this case, after the bonus game process has been carried out in S15, a payout process for the base game and the bonus game is carried out (S16), and the main process program is finished. On the contrary, in the event that, in the selection process in S12, for example, a total of three or more of the SARDINE symbols (sardine) does not appear (displayed in a stationary form), regardless of the activated pay line, in the variable display windows 21 to 25, the bonus game is not won (S14). In this case, therefore, the payout process for the base game is carried out (S16), and the main process program is finished.

At this point, a description will be given of the start reception process carried out on the slot machine 1. FIG. 18 is a flowchart illustrating the start reception process. First, it is determined in S21 whether or not a prescribed time (for example, fifteen seconds) has elapsed. At this point, if the prescribed time has not elapsed (S21), it is determined whether or not a BET button has been depressed (S23). If the prescribed time has elapsed in S21 (S21), after a demo effect is executed on the upper liquid crystal display 3 and the lower crystal display 4 (S22), it is determined whether or not a BET button has been depressed (S23).

Then, in S23, it is determined whether or not the BET 1 PER LINE button 33 operation, the BET 2 PER LINE button 34 operation, the BET 3 PER LINE button 35 operation, the BET 5 PER LINE button 36 operation or the BET 8 PER LINE button 37 operation has been performed. At this point, if the operation of the BET 1 PER LINE button 33 or the like has not been performed (S23), the process returns to S21 where the previously described process is repeated. On the contrary, if the operation of the BET 1 PER LINE button 33 or the like has been performed (S23), it is determined whether or not the LINE ACTIVE button 39 has been depressed even if the demo effect is still in progress (S24).

If the LINE ACTIVE button 39 has been depressed, after a line active process has been carried out (S26), it is determined whether or not the WIN START button 38 has been depressed (S25). On the contrary, if the LINE ACTIVE button 39 has not been depressed, it is determined whether or not the WIN START button 38 has been depressed (S25). Then, if the WIN START button 38 has been depressed, the selection process is carried out even if the demo effect is still in progress.

Next, a description will be given of a line active process program carried out on the slot machine 1. FIG. 19 is a flowchart illustrating the line active process program. As described heretofore, the line active process is one which is executed in a case in which the player desires to cause the activated pay line to be displayed in the variable display windows 21 to 25. In the event that the LINE ACTIVE button 39 has been depressed once, the activated pay line corresponding to the number of bets is displayed in the variable display windows 21 to 25. In this condition, it is determined whether or not the prescribed time has elapsed (S31). If the prescribed time has elapsed, the state is established in which the activated pay line corresponding to the number of bets is displayed in the variable display windows 21 to 25. On the contrary, if the prescribed time has not elapsed, it is determined whether or not the LINE ACTIVE button 39 has been depressed again (S32). This operation is carried out in a case in which the player intends to cause not the activated pay line corresponding to the number of bets but, for example, the symbol display areas related to the bonus game to be displayed, or in like cases.

Then, in the event that the LINE ACTIVE button 39 has been depressed again, the second symbol display areas are displayed (line L1 is active) (S33). In this condition, it is determined whether or not the prescribed time has elapsed (S34). If the prescribed time has elapsed, the state is established in which the second symbol display areas are displayed. On the contrary, if the prescribed time has not elapsed, it is determined whether or not the LINE ACTIVE button 39 has been depressed again (S35). Then, if the LINE ACTIVE button 39 has been depressed again, the first symbol display areas are displayed (line L2 is active) (S36). In this condition, it is determined whether or not the prescribed time has elapsed (S37). If the prescribed time has elapsed, the state is established in which the first symbol display areas are displayed. On the contrary, if the prescribed time has not elapsed, it is determined whether or not the LINE ACTIVE button 39 has been depressed again (S38). Then, if the LINE ACTIVE button 39 has been depressed again, the third symbol display areas are displayed (line L3 is active) (S39). In this condition, it is determined whether or not the prescribed time has elapsed (S40). If the prescribed time has elapsed, the state is established in which the third symbol display areas are displayed. On the contrary, if the prescribed time has not elapsed, it is determined whether or not the LINE ACTIVE button 39 has been depressed again (S41). If the LINE ACTIVE button 39 has been depressed again, the second symbol display areas are displayed again (line L1 is active) (S33). On the contrary, if the LINE ACTIVE button 39 has not been depressed, the process returns to the main process program.

In this way, in the slot machine 1 according to this embodiment, by an intentional depressing of the LINE ACTIVE button 39 by the player, it is possible to display the activated pay line in the variable display windows 21 to 25. For this reason, even though the number of activated pay lines is increased, the player can recognize the activated pay lines. Also, the configuration capable of selectively displaying the first to third symbol display areas as the predetermined display areas makes it easy for the player, from the aspect etc. of winning a bonus when specified symbols have been displayed in a stationary form in specified symbol display areas, to recognize the symbol display areas related to the winning of the bonus. Thus, it is possible to increase the player's interest in the bonus game.

Next, a description will be given of a selection process program carried out on the slot machine 1. FIG. 20 is a flowchart illustrating the selection process program. First, a symbol determining process is carried out (S51). In this process, the symbol to be displayed in a stationary form on the first pay line L1 in the base game is determined for each of the variable display windows 21 to 25. Specifically, five random number values to correspond with each of the variable display windows 21 to 25 are sampled by the random number sampling circuit 56, and the symbols to be displayed in a stationary form are determined via code numbers based on the selection table shown in FIG. 21. Then, when the symbols to be displayed in a stationary form on the activated pay lines have been determined, after a winning combination evaluation process has been carried out (S52), the process proceeds to the base game process. In the winning combination evaluation process, to be specific, the winning combinations and the awards thereof are determined based on the table in FIG. 22 via the code numbers in S51.

At this point, using FIG. 21, a description will be given of the selection table which is used when determining the symbols to be displayed in a stationary form on the activated pay line L1 shown in FIG. 7 in a case of performing the base game on the slot machine 1 using the five variable display windows 21 to 25. FIG. 21 shows the selection table which selects the symbols to be displayed in a stationary form in the case of performing the base game using the five variable display windows. The symbols displayed in a stationary form on the activated pay line L1 are determined for each of the variable display windows 21 to 25. That is the reason for providing the selection table which allots a code number from 00 to 29, in order from the top, to each of the symbol columns on the reel bands 101 to 105 displayed in a scrolling form in the respective variable display windows 21 to 25. Then, five random number values to correspond with each of the variable display windows 21 to 25 are sampled by the random number sampling circuit 56.

Next, a description will be given of a base game process program carried out on the slot machine 1. FIG. 23 is a flowchart illustrating the base game process program. First, based on the switch signal transmitted from a 1-LINE switch 62, a 2-LINES switch 63, a 5-LINES switch 64, a 20-LINES switch 65 and a 25-LINES switch 65, the start of which has been received, a scrolling of each symbol is carried out in the variable display windows 21 to 25 (S61). Then, the scrolling of each symbol in the variable display windows 21 to 25 is stopped (S62). Subsequently, the credits etc. equivalent to the award, which has been determined based on the table shown in FIG. 22 in accordance with the winning combination of symbols displayed in a stationary form in the variable display windows 21 to 25, are added (S63). After the addition process, the process returns to the main process program to determine whether or not the bonus game has been won.

At this point, a description will be given of the winning combinations and the awards thereof in the case of performing the base game on the slot machine 1 using the five variable display windows 21 to 25. FIG. 22 shows the winning combinations and the awards thereof in the case of performing the base game using the five variable display windows, wherein the award is shown in a case in which the number of bets is one. Consequently, although the award value shown in FIG. 22 is added to the credits in the event that the number of bets is one, in the event that the number of bets is two or more, the product of the relevant number of bets and the award value shown in FIG. 22 is added to the credits.

For example, regarding the LOBSTER symbol (lobster) in FIG. 22, in the event that it is consecutively displayed in a stationary form on an activated pay line in the variable display windows 21 and 22 (in the case of 2K in which two appear consecutively from the left end), an award of 10 is obtained. Also, in the event that it is consecutively displayed in a stationary form on an activated pay line in the variable display windows 21 to 23 (in the case of 3K in which three appear consecutively from the left end), an award of 320 is obtained. Also, in the event that it is consecutively displayed in a stationary form on an activated pay line in the variable display windows 21 to 24 (in the case of 4K in which four appear consecutively from the left end), an award of 2500 is obtained. Also, in the event that it is consecutively displayed in a stationary form on an activated pay line in the variable display windows 21 to 25 (in the case of 5K in which five appear consecutively from the left end), an award of 6000 is obtained. In this way, the award is determined by a symbol and the number of times the symbol is consecutively displayed in a stationary form. Then, in the event that the award for the symbol is on a plurality of activated pay lines, the total value of all the awards is added to the credits.

At this point, regarding the SARDINE symbol (sardine), in the case of 2K in which two appear (displayed in a stationary form), regardless of the activated pay line, in the variable display windows 21 to 25, an award of 2 is obtained, in the case of 3K in which three appear (displayed in a stationary form), an award of 5 is obtained, in the case of 4K in which four appear (displayed in a stationary form), an award of 10 is obtained, and in the case of 5K in which five appear (displayed in a stationary form), an award of 125 is obtained. Only in the case of the award for the SARDINE symbol (sardine), the product of the total number of bets (the product of the number of bets and the number of activated pay lines) and the award value shown in FIG. 22 is added to the credits. At this time, in the event that there is an award other than for the SARDINE symbol (sardine), that award is also added to the credits. Also, regarding the SARDINE symbol (sardine), in the event that a total of three or more appear (displayed in a stationary form) in the variable display windows 21 to 25, as well as obtaining the award regardless of the activated pay line, it is possible to make a transition to the bonus game. As used herein, the bonus game is a game which is performed after the base game has been performed, wherein it is often the case that it is a game which in general is beneficial to the player. At this point, when a transition is made to the bonus game, fifteen to twenty-five games are automatically performed consecutively in accordance with a selection result when a transition is made to the bonus game, with no need to bet the credits or the like. In this embodiment, although a description is given of the case of using the SARDINE symbol (sardine) as a special symbol such as described heretofore, it is acceptable to set a symbol other than the SARDINE symbol (sardine) as the special symbol.

Next, a description will be given of a bonus game process program carried out on the slot machine 1. FIG. 24 is a flowchart illustrating the bonus game process program. In the main process program, if it is determined that the bonus game has been won, first, the selection process in the bonus game is carried out (S71). In this process, in the bonus game, the symbol to be displayed in a stationary form on the first pay line L1 is determined for each of the variable display windows 21 to 25. Specifically, as described heretofore, five random number values to correspond with each of the variable display windows 21 to 25 are sampled by the random number sampling circuit 56, and the symbols to be displayed in a stationary form are determined via the code numbers based on the selection table shown in FIG. 21. Then, when the symbols to be displayed in a stationary form on the first pay line L1 have been determined, the winning combinations and the awards thereof are determined based on the table shown in FIG. 22 via the code numbers.

Then, the scrolling of each symbol in the variable display windows 21 to 25 is automatically carried out (S72). Subsequently, the scrolling of each symbol in the variable display windows 21 to 25 is stopped (S73). Then, the credits etc. equivalent to the award, which has been determined based on the table shown in FIG. 22 in accordance with the winning combination of symbols displayed in a stationary form in the variable display windows 21 to 25, are added (S74). Subsequently, it is determined whether or not a bonus game execution number has reached the number determined in the selection process in the main process program (S75). At this time, if the bonus game execution number has not reached the number determined in the selection process in the main process program (S75), the selection process for the bonus game is carried out (S71). Meanwhile, if the number determined in the selection process in the main process program has been reached (S75), the bonus game process program is finished.

In the event that the bonus game has been won, a bonus game repetition number is determined again, and the determined repetition number is added to the “number determined in the selection process in the main process program” in the evaluation in S75. By this means, in the event that a bonus game is won during the bonus game, a transition can be made again to the bonus game. To be specific, for example, in a case of making a transition for the first time to twenty bonus games, in the event that seventeen bonus games are won in the twelfth of the twenty bonus games, twenty five (twenty games−twelve games+seventeen games) bonus games are performed after that. Also, in the event that credits have eventually been obtained in a bonus game, a double down game on which the credits are bet is performed after the bonus game is finished, the details of which will be omitted. Furthermore, the number of bets and the number of activated pay lines at the time of making a transition to the bonus game are used during the bonus game. Further still, the winning combinations and the awards thereof in the bonus game are the same as those in the base game described heretofore. In this way, the base game and the bonus game are performed on the slot machine 1.

In the aforementioned description, a description is given of the case in which the LINE ACTIVE operation is a depression of the LINE ACTIVE button 39. The invention can similarly be applied to the case in which the LINE ACTIVE operation is a touch of the touch panel 121. At this point, a description will be given of another example of the start reception process program carried out on the slot machine 1. FIG. 25 is a flowchart illustrating another example of the start reception process program. First, in S81, it is determined whether or not a prescribed time (for example, fifteen seconds) has elapsed. At this point, if the prescribed time has not elapsed (S81), it is determined whether or not a BET button has been depressed (S83). If the prescribed time has elapsed in S81 (S81), after the demo effect is carried out on the upper liquid crystal display 3 and the lower liquid crystal display 4 (S82), it is determined whether or not a BET button has been depressed (S83).

Then, in S83, it is determined whether or not the operation of the BET 1 PER LINE button 33 or the like has been performed. At this point, if the operation of the BET 1 PER LINE button 39 or the like has not been performed (S83), the process returns to S81 where the previously described process is repeated. Meanwhile, if the operation of the BET 1 PER LINE button 39 or the like has been performed (S83), it is determined whether nor not the LINE ACTIVE button 39 has been depressed even if the demo effect is still in progress. That is, at this point, it is determined whether or not a prescribed place of the touch panel 121, for example, a LINE ACTIVE icon, has been touched (S84).

If the LINE ACTIVE icon has been touched, after the line active process has been carried out (S86), it is determined whether or not the WIN START button 38 has been depressed (S85). Meanwhile, if the LINE ACTIVE icon has not been touched, it is determined whether or not the WIN START button 38 has been depressed (S85). Then, if the WIN START button 38 has been depressed, the selection process is carried out even if the demo effect is still in progress.

Next, a description will be given of another example of the LINE ACTIVE process program carried out on the slot machine 1. FIG. 26 is a flowchart illustrating another example of the line active process program. If the LINE ACTIVE icon has bee touched, the activated pay line corresponding to the number of bets is displayed in the variable display windows 21 to 25. In this condition, it is determined whether or not a prescribed time has elapsed (S91). If the prescribed time has elapsed, the state is established in which the activated pay line corresponding to the number of bets is displayed in the variable display windows 21 to 25. Meanwhile, if the prescribed time has not elapsed, it is determined whether or not the second symbol display areas (pay line L1) have been touched (S92).

Then, if the second symbol display areas (pay line L1) have been touched, the second symbol display areas are displayed (the line L1 is active) (S93). Also, it is determined whether or not the first symbol display areas (pay line L2) have been touched (S94), and if the first symbol display areas (play line L2) have been touched, the first symbol display areas are displayed (the line L2 is active) (S95). Also, it is determined whether or not the third symbol display areas (pay line L3) have been touched (S96), and if the third symbol display areas (play line L3) have been touched, the third symbol display areas are displayed (the line L3 is active) (S97). In this way, the process returns to the main process program with the activated pay line or the desired areas placed in the active state.

In this way, by touching the desired place on the touch panel 121 even in the case of the processes shown in FIGS. 25 and 26, that is, on the player's own intent, it is possible to display the activated pay line in the variable display windows 21 to 25. For this reason, even though the number of activated pay lines is increased, the player can recognize the activated pay lines. Also, the configuration capable of selectively displaying the first to third symbol display areas as the predetermined display areas makes it easy for the player, from the aspect etc. of winning a bonus when specified symbols have been displayed in a stationary form in specified symbol display areas, to recognize the symbol display areas related to the winning of the bonus. Thus, it is possible to further increase the player's interest in the bonus game.

The invention is not limited to the aforementioned embodiment, but various modifications can be made thereto and practiced. For example, the layout and buttons of the slot machine, the winning contents of the slot machine and the like, which have been described in the aforementioned embodiment, are one example and can be modified as appropriate. Also, the line active operation of the aforementioned embodiment is illustrative, and all the operations of displaying the activated pay line in the variable display windows on the player's own intent and displaying the desired areas of the variable display windows are included in the line active operation. Any other modifications can be made as appropriate and practiced without departing from the scope of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine comprising: a display device which displays a plurality of symbol display areas; a game controller which pays out a playing value in response to a symbol combination on at least one activated pay line; and a line active module which causes the activated pay line to be displayed on the a plurality of symbol display areas according to an input operation.

2. A gaming machine according to claim 1, wherein the line active module activates a predetermined display area of the plurality of symbol display areas.
